(19) United States
(12) Patent Application Publication
(10) Pub. No.: US 2016/0016187 A1
(43) Pub. Date: Jan. 21, 2016

(54) Lawn sprinkler adapter

(71) Applicant: Uelysee A. SCANTLING, Brookfield, CT (US)

(72) Inventor: Uelysee A. SCANTLING, Brookfield, CT (US)

(21) Appl. No.: 14/635,332

(22) Filed: Mar. 2, 2015

Related U.S. Application Data
(60) Provisional application No. 62/024,727, filed on Jul. 15, 2014.

(51) Int. Cl. B05B 7/30; B01F 5/04; F04F 5/02

(52) U.S. Cl. CPC B05B 7/30; F04F 5/02; B01F 5/0403

(57) ABSTRACT

An adapter is provided for connection with a garden hose and a lawn sprinkler or other fluid dispersion devices, which mixes a substance stored in a reservoir connected to the adapter, with water for spraying onto a lawn or other area.

### CROSS REFERENCE TO RELATED APPLICATIONS

This application claims the benefit of U.S. Provisional Patent Application No. 62/024,727 filed Jul. 15, 2014, which is hereby incorporated by reference in its entirety.

### FIELD OF THE INVENTION

The present invention relates to an adapter configured for use with a sprinkler or hose for mixing a substance with water for spraying onto a lawn or other area via the sprinkler or hose.

### BACKGROUND OF THE INVENTION

There are devices known in the art that permit an individual to dispense a chemical or other substance from a garden hose. However, such devices are generally spray bottles, which are attached to the end of a hose and require the user to hold the spray bottle and manually dispense the chemical by using a nozzle on the spray bottle.

The present invention addresses these shortcomings in the art by providing an adapter that allows a mixture of water and another substance to be distributed from a garden hose using any number of dispersion devices and with greater convenience to the user.

### SUMMARY OF THE INVENTION

According to a first aspect of the invention, a garden hose adapter is provided which includes a hollow, tubular connector, a vacuum tube, and a reservoir. The tubular connector has a first open end, a second open end, a female garden hose fitting surrounding the first open end, a male garden hose fitting surrounding the second open end, and an aperture positioned between the first open end and second open end. The vacuum tube is inserted into the aperture in the connector and is oriented substantially perpendicularly to the connector. The reservoir is secured to the connector and can be filled with a substance or fluid. The female garden hose fitting of the connector is secured to a garden hose via a corresponding male garden hose fitting on the open end of the garden hose. The vacuum tube is inserted into the reservoir to intake the substance, which passes through into the connector for mixing with water or other fluid passing through the connector via the garden hose. A mixture is thereby created, which is discharged from the second open end of the connector.

According to an embodiment of the first aspect of the invention, the male garden hose fitting on the second open end of the connector is secured to a sprinkler via a corresponding female fitting on the sprinkler.

According to an alternative embodiment of the first aspect of the invention, the male garden hose fitting on the second open end of the connector is secured to a hose via a corresponding female fitting on the hose.

According to a further alternative embodiment of the first aspect of the invention, the male garden hose fitting on the second open end of the connector is secured to a spray nozzle via a corresponding female fitting on the spray nozzle.

According to an embodiment of the first aspect of the invention, the reservoir is a container comprising a lid, and the vacuum tube in inserted through an opening in the lid into the container. The garden hose adapter can be secured to the lid by snapping the connector into a slot on the lid. The container and lid may each comprise corresponding threaded sections for securing the lid to the container.

According to an embodiment of the first aspect of the invention, a restrictor valve configured to increase or decrease the size of the vacuum aperture. The container lid, the restrictor valve, and the vacuum tube are arranged to form an airtight seal. The airtight seal creates a vacuum.

According to a second aspect of the invention, a garden hose adapter kit is provided which includes a hollow, tubular connector, a vacuum tube, and a reservoir. The tubular connector has a first open end, a second open end, a female garden hose fitting surrounding the first open end, a male garden hose fitting surrounding the second open end, and an aperture positioned between the first open end and second open end. The vacuum tube, which has a first length, is configured to be inserted into the aperture in the connector and oriented substantially perpendicularly to the connector. The reservoir has a first volume and is secured to the connector and can be filled with a substance or fluid. The female garden hose fitting of the connector is configured to be secured to a garden hose via a corresponding male garden hose fitting on the garden hose. The vacuum tube is configured to be inserted into the reservoir to intake the substance, which passes through into the connector for mixing with water or other fluid passing through the connector via the garden hose. A mixture is thereby created, which is discharged from the second open end of the connector.

In an embodiment of the second aspect of the invention, the kit includes at least a second vacuum tube having a second length, different from the first length.

In an embodiment of the second aspect of the invention, the kit includes at least a second reservoir having a second volume, different from the first volume.

In an embodiment of the second aspect of the invention, the kit includes a sprinkler for securing to the male garden hose fitting on the second open end of the connector or to a hose secured to the male garden hose fitting of the connector.

In a further embodiment of the second aspect of the invention, the kit includes a garden hose for securing to the male garden hose fitting on the second open end of the connector.

In a further embodiment of the second aspect of the invention, the kit includes a spray nozzle for securing to the male garden hose fitting on the second open end of the connector or to a hose secured to the male garden hose fitting of the connector.

According to an embodiment of the second aspect of the invention, the reservoir is a container comprising a lid, and the vacuum tube in inserted through an opening in the lid into the container. The garden hose adapter can be secured to the lid by snapping the connector into a slot on the lid. The container and lid can each comprise corresponding threaded sections for securing the lid to the container.

According to an embodiment of the second aspect of the invention, the kit comprises a restrictor valve configured to increase or decrease the size of the vacuum aperture.

### BRIEF DESCRIPTION OF THE DRAWINGS

FIG. 1 shows an embodiment of the adapter according to the present invention;

FIG. 2 shows a first view of the connector and vacuum tube of the adapter according to an embodiment of the invention;

FIG. 3 shows a second view of the connector and vacuum tube of the adapter according to an embodiment of the invention;

FIG. 4 shows the reservoir of the adapter according to an embodiment of the invention; and

FIG. 5 shows the connector and vacuum tube and the reservoir according to an embodiment of the invention.

### DETAILED DESCRIPTION OF THE INVENTION

The present invention will now be described with reference made to Figures through 5.

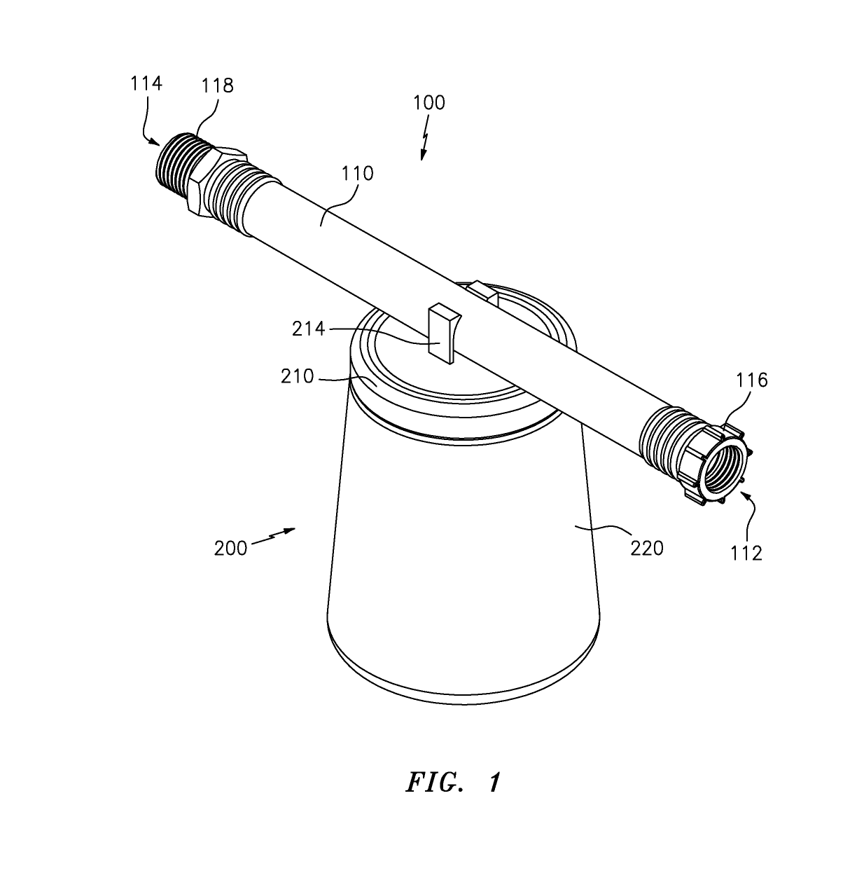

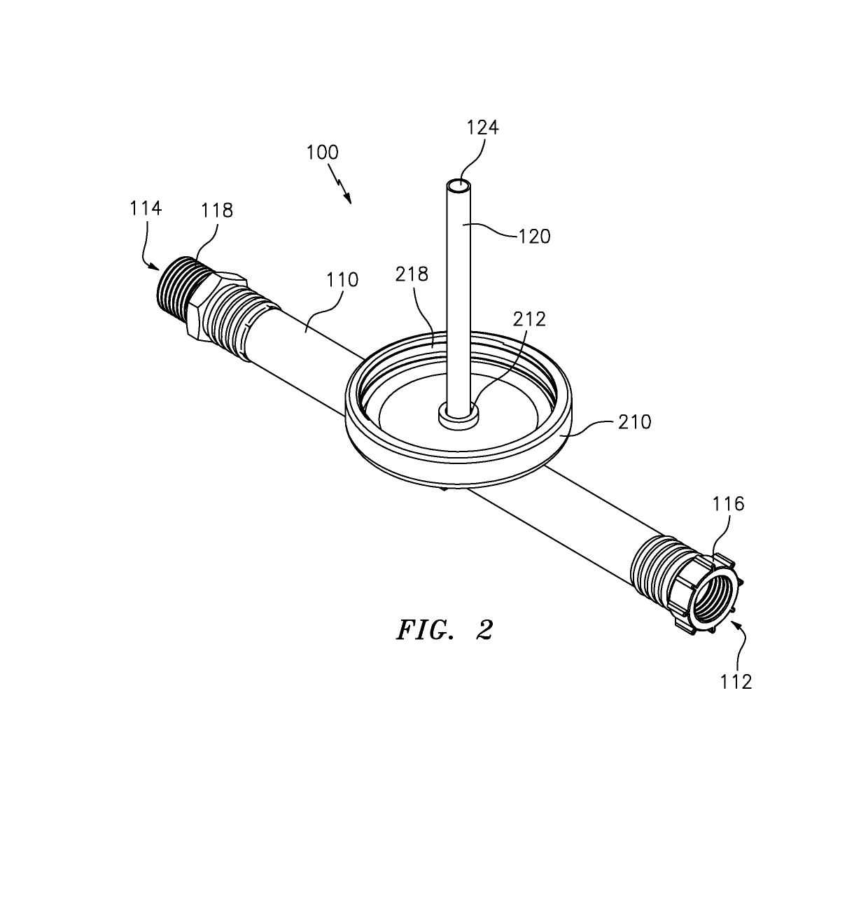

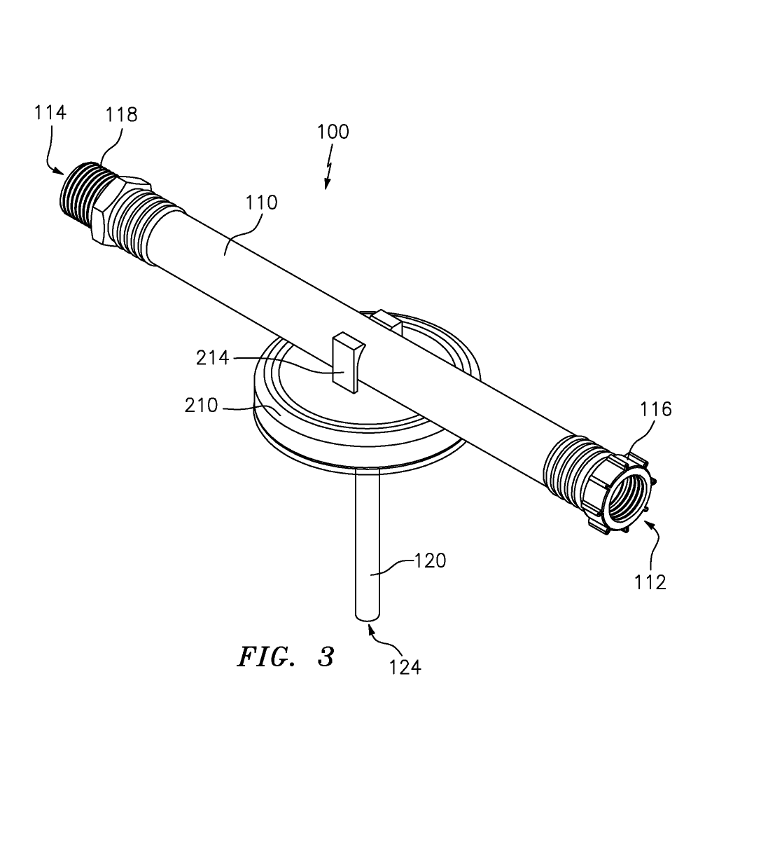

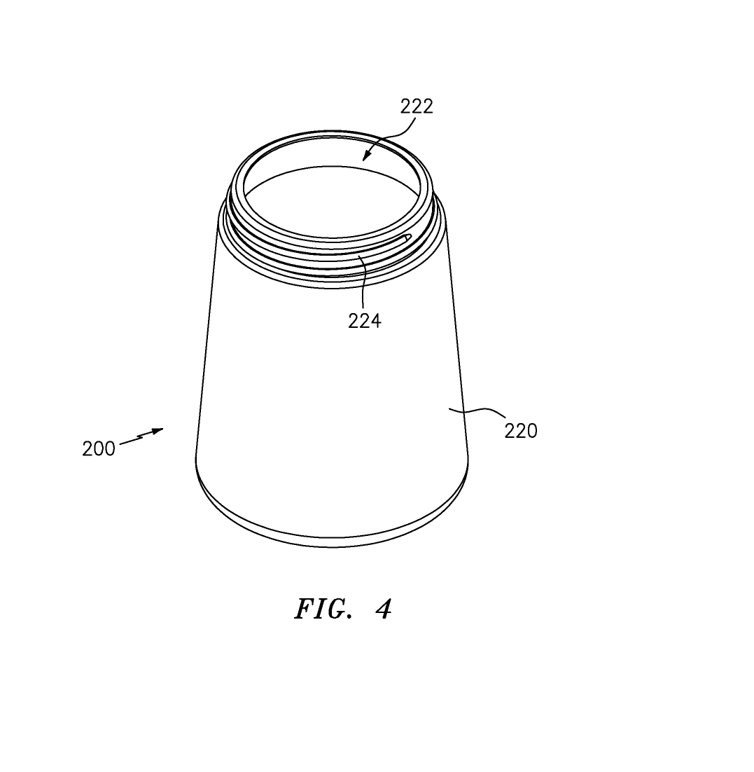

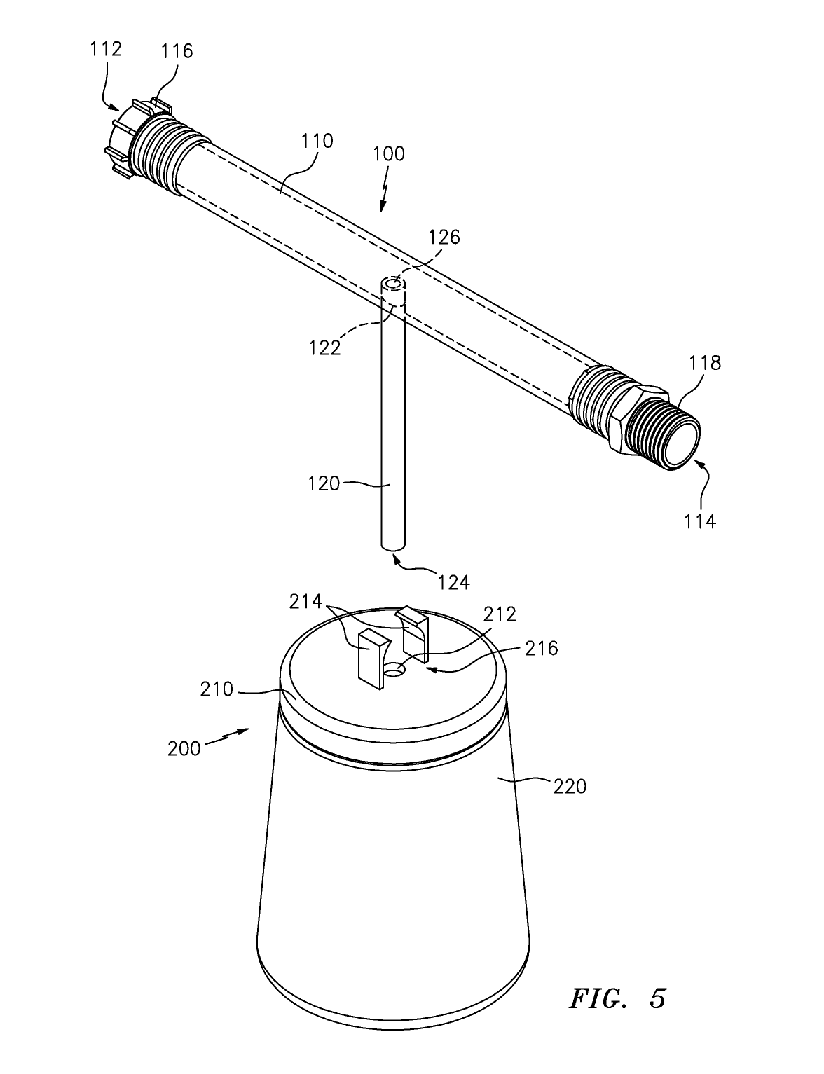

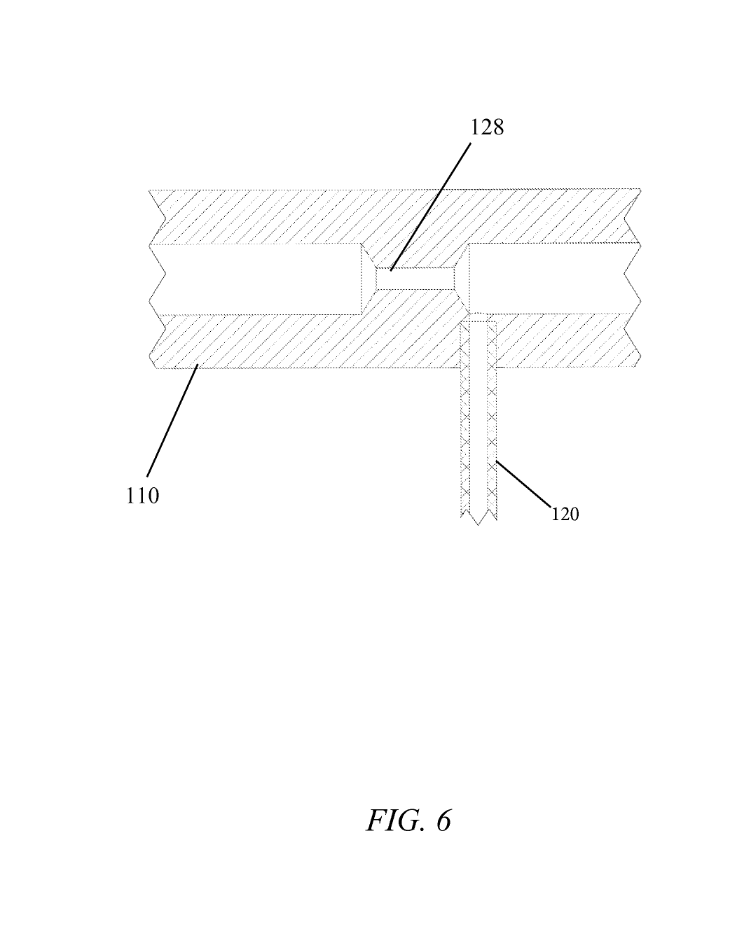

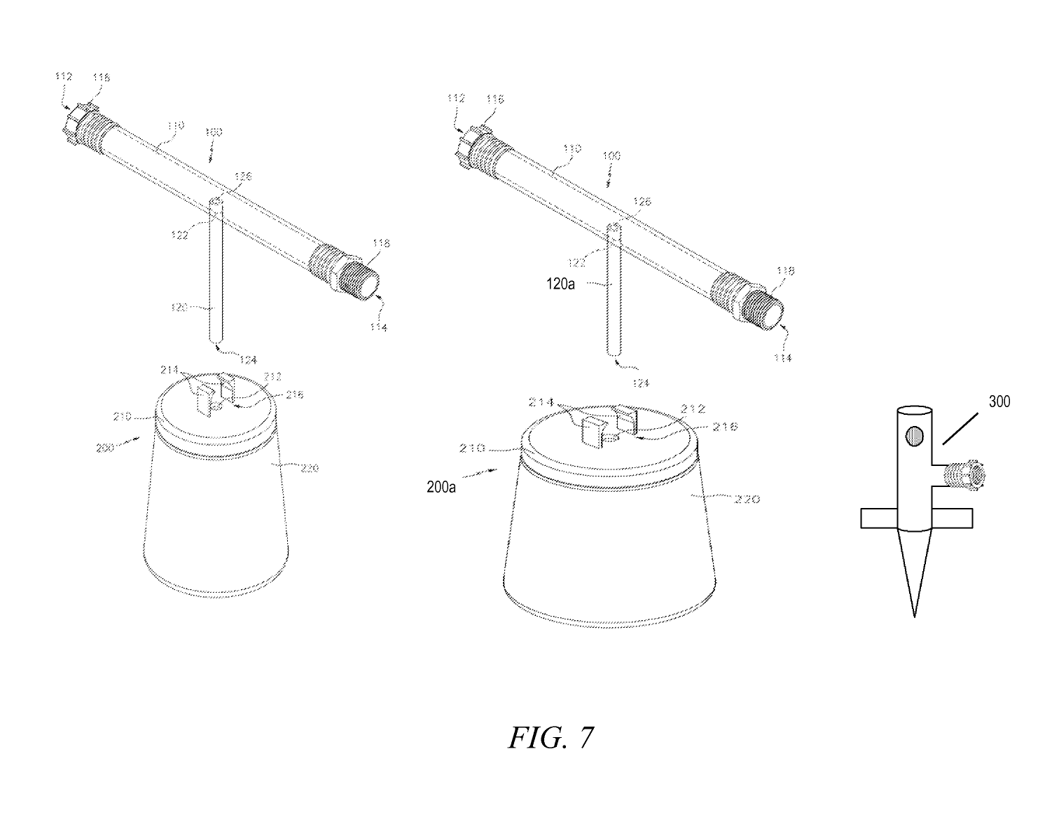

As shown for example in FIG. 1, according to the present invention, a garden hose adapter 100 is provided that comprises a connector 110 secured to a reservoir 200.

The connector 110 is hollow and tubular, having a similar shape and circumference as that of a garden hose. The connector 110 comprises a first open end 112 and an opposing, second open end 114. Positioned on the first open end 112 is a standard, female garden hose fitting 116 and positioned on the second open end 114 is a standard, male garden hose fitting 118. The female garden hose fitting 116 is capable of receiving a corresponding male fitting on a garden hose, allowing the connector 110 and adapter 100 to be secured to a garden hose. The male garden hose fitting 118 is capable of receiving a corresponding female fitting on separate object, such as a sprinkler, a second hose, a spray nozzle, or other hose attachment device. For example, a first hose configured to discharge water can be attached to the connector 110 on the first open end 112 via the female garden hose fitting 116, and a second hose can be attached to the second open end 114 via the male garden hose fitting 118, wherein the second hose is itself connected to a sprinkler on its end not attached to the connector 110. The connector 110 can be made from a rubber or plastic material, or from any other suitable material known in the art.

The adapter 100 further comprises a vacuum tube 120 inserted through a vacuum aperture 122 positioned along the length of the connector 110. The vacuum tube 120 comprises a first open end 124 that is to be inserted into the reservoir 200 and a second open end 126 that is inserted through the vacuum aperture 122 to be positioned inside the connector 110. The vacuum tube 120 can be secured to the connector 110 by constriction of the vacuum aperture 122 around the vacuum tube 120, by a clamp or by any other suitable means known in the art.

In a preferred embodiment of the invention shown in the Figures, the reservoir 200 is a container 220 provided with a lid 210. In a preferred embodiment, the reservoir 200 is a container 220 having an oblong shape and a flat bottom, such that the adapter 100 can be easily connected to and rest upon the lid 210 along the length of the adapter 100, and the reservoir 200 can rest on the ground. However, the reservoir 200 and container 220 are not limited to this shape and configuration, but in other embodiments as shown in the Figures, can come in different shapes. The lid 210 comprises an opening 212 dimensioned to allow the vacuum tube 120 to pass through the lid 210, from the adapter 110 into the container 220. The lid 210 is further secured to the connector 110 in a preferred embodiment. In the embodiment shown in the Figures, the lid 210 comprises a pair of tabs 214 that form a slot 216 for receiving the connector 110 and keeping the connector 110 in place attached to the lid 210. The tabs 214 may comprise projections configured to prevent the connector 110 from being removable from the slot 216 unless an individual manually removes the connector 110. In alternative embodiments, the connector 110 can be secured to the lid 210 by other mechanisms, such as one or more hooks, loops or straps positioned on the lid for receiving and securing around the connector 110, a series of corresponding connecting elements such as snaps positioned along the connector 110 and lid 210, or an adhesive.

In the embodiment shown in the Figures, the lid 210 and container 220 each comprise a threaded portion 218 and 224, respectively, which allow the lid 210 and container 220 to be secured together by way of screwing the lid 210 over the opening 222 of the container 220. However, the lid 210 and container 220 can be secured to each other using other mechanisms, such as a fitted snap arrangement for example. This arrangement allows the reservoir 200 to be conveniently accessed for refilling and/or emptying by, for example, taking the lid 210 off of the container 220. The lid 210 may also be removable from its attachment to the connector 110, so that an alternate reservoir 200 can be used as part of the adapter 100.

During operation, a hose is connected to the first end of the connector 110 and the vacuum tube 120 is inserted into the reservoir 200, which is filled with a substance that a person wishes to spray on his or her lawn or onto a particular area or object. This allows a solution to be mixed between the water flowing through the hose and connector 110, and the substance in the reservoir 200, which is pulled through the vacuum tube 120 into the connector 110 having the running water. This mixture is discharged through the second end 114 of the connector 110, which for example may be connected to a lawn sprinkler, so that the mixture is discharged through the sprinkler.

The dimensions of the vacuum tube 120 and vacuum aperture 122 are related to the rate that the substance in the reservoir 200 that is extracted and mixed with water. Although the present invention in not limited to a particular set of dimensions, in one embodiment of the invention, the vacuum aperture 122 in the connector 110 is approximately 3 millimeters in diameter, and the vacuum tube has a length of approximately 8 centimeters. This arrangement would create a spread rate ratio of approximately 1 liter of the substance in the reservoir 200 per 5 gallons of water sprayed. The spread rate or amount of substance used per volume of water sprayed can be adjusted by altering the diameter of the vacuum aperture 122 and/or altering the length of the vacuum tube 120. For example, the size of the vacuum aperture 122 can be manipulated by a mechanical restrictor valve to increase or decrease the diameter of the vacuum aperture 122. Alternatively, the vacuum tube 120 can be removed and replaced with a different vacuum tube 120 having a different length. The container lid 210, the restrictor valve, and the vacuum tube 120 are arranged to form an airtight seal, creating a vacuum.

In a preferred embodiment, the reservoir 200 has a flat bottom, so that the reservoir 200 and adapter 100 may rest on the flat ground without needing to be held by the person using the adapter 100. This allows the adapter to be conveniently laid on the ground during use or wherever needed. In a preferred embodiment, the reservoir may have a volume of 1 liter. However, the reservoir 200 is not limited to any particular volume or set of dimensions and reservoirs 200 having different sizes can be used with the adapter 100.

According to a further embodiment of the invention, a kit is provided comprising the connector 110, the vacuum tube 120 and the reservoir 200, including lid 210 and container 220. The kit may further include articles that are configured for attachment to and use with the connector 110, including a hose, sprinkler or spray nozzle. The kit may further include multiple vacuum tubes 120 having different lengths and diameters and multiple reservoirs 200, which can include reservoirs 200 having different sizes.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. A garden hose adapter comprising:
a hollow, tubular connector comprising:
a first open end;
a second open end;
a female garden hose fitting surrounding the first open end;
a male garden hose fitting surrounding the second open end; and
an aperture in the connector at a position between the first open end and second open end;
a vacuum tube inserted into the aperture in the connector and positioned to be substantially perpendicular to the connector; and
a reservoir secured to the connector;
wherein the female garden hose fitting is secured to a garden hose via a corresponding male garden hose fitting;
wherein the vacuum tube is configured to be inserted into the reservoir, which comprises a substance, and to intake said substance into the connector for mixing with water or other fluid passing through the connector via the garden hose to create a mixture which is discharged from the second open end of the connector;
wherein the reservoir is a container comprising a lid, and a vacuum tube is inserted through an opening in the lid into the container;
wherein the lid comprises a plurality of tabs forming a slot adjacent to the opening in the lid and projecting from a top surface of the lid; and
wherein a portion of the connector is inserted into the slot projecting from the lid to removably secure the connector to the reservoir.

2. The garden hose adapter according to claim 1, wherein the male garden hose fitting of the connector is secured to a sprinkler via a corresponding female fitting on the sprinkler.

3. The garden hose adapter according to claim 1, wherein the male garden hose fitting of the connector is secured to a hose via a corresponding female fitting on the hose.

4.-6. (canceled)

7. The garden hose adapter according to claim 1, wherein the container and lid each comprise corresponding threaded sections for securing the lid to the container.

8. The garden hose adapter according to claim 1, further comprising a restrictor valve.

9. The garden hose adapter according to claim 1, wherein the reservoir has an oblong shape and a flat bottom.

10. A kit comprising:
a hollow, tubular connector comprising:
a first open end;
a second open end;
a female garden hose fitting surrounding the first open end;
a male garden hose fitting surrounding the second open end; and
an aperture in the connector at a position between the first open end and second open end;
at least one vacuum tube comprising a first length and configured to be inserted into the aperture in the connector and positioned to be substantially perpendicular to the connector; and
at least one reservoir having a first volume secured to the connector;
wherein the female garden hose fitting is configured for securing to a garden hose via a corresponding male garden hose fitting;
wherein the vacuum tube is configured to be inserted into the reservoir, which comprises a substance, and to intake said substance into the connector for mixing with water or other fluid passing through the connector via the garden hose to create a mixture which is discharged from the second open end of the connector;
wherein the reservoir is a container comprising a lid, and a vacuum tube is inserted through an opening in the lid into the container;
wherein the lid comprises a plurality of tabs forming a slot adjacent to the opening in the lid and projecting from a top surface of the lid; and
wherein a portion of the connector is inserted into the slot projecting from the lid to removably secure the connector to the reservoir.

11. The kit according to claim 10, further comprising at least a second vacuum tube having a second length different from the first length.

12. The kit according to claim 10, further comprising at least a second reservoir having a second volume different from the first volume.

13. The kit according to claim 10, further comprising a sprinkler for securing to the male garden hose fitting of the connector or to a hose secured to the male garden hose fitting of the connector.

14. The kit according to claim 10, further comprising a garden hose for securing to the male garden hose fitting of the connector.

15.-17. (canceled)

18. The kit according to claim 10, wherein the container and lid each comprise corresponding threaded sections for securing the lid to the container.

19. The kit according to claim 10, further comprising a restrictor valve.

20. The kit according to claim 10, wherein the reservoir has an oblong shape and a flat bottom.

21. The garden hose adapter according to claim 1, wherein the portion of the connector inserted into the slot is a tubular portion along the length of the connector.

22. The garden hose adapter according to claim 1, wherein the plurality of tabs each comprise a projection at an end of the tab and substantially perpendicular to the tab configured to further secure the connector to the reservoir.

23. The kit according to claim 10, wherein the portion of the connector inserted into the slot is a tubular portion along the length of the connector.

24. The kit according to claim 10, wherein the plurality of tabs each comprise a projection at an end of the tab and substantially perpendicular to the tab configured to further secure the connector to the reservoir.
